(19) United States
(12) Patent Application Publication
(10) Pub. No.: US 2012/0282012 A1
(43) Pub. Date: Nov. 8, 2012

(54) Vacuum container with a body and a base which are conveniently disassembled and assembled

(75) Inventor: Wei HUANG, GUANGDONG (CN)

(73) Assignee: GUANGZHOU HEKOUMEI HOUSEWARE DEVELOPMENT CO. LTD., GUANGDONG (CN)

(21) Appl. No.: 13/288,034

(22) Filed: Nov. 3, 2011

(30) Foreign Application Priority Data
May 6, 2011 (CN) 201120141063.0

(51) Int. Cl. F16D 1/08

(52) U.S. Cl. 403/13

(57) ABSTRACT

A vacuum container with a body and a base which are conveniently disassembled and assembled comprises a body (1) and a base (2), The body (1) has a bottom side disposed with an upper connecting ring (3); the base (2) has an upper side disposed with a lower connecting ring (4); the lower connecting ring (4) is disposed with a rotatable fastening member (5) in middle; the fastening member (5) is disposed with art “I”-shaped fastening bar (6) on top; the upper connecting ring (3) is disposed with an “I”-shaped opening (7) for the fastening bar (6) to pass through; the upper connecting ring (3) has an upper side disposed with a fastening recess (8) which engages the fastening bar (6) after the fastening bar (6) rotates 90 degrees. The fastening member could lock the body and the base together after it is manually rotated for 90 degrees.

### BACKGROUND OF THE INVENTION

The present invention relates to a vacuum container and more particularly pertains to a vacuum container with a body and a base which are conveniently disassembled and assembled.

Currently, the body and the base of a vacuum container available in the prior art are assembled together by means of welding, rivets, threaded connection and so forth. However, such assembling methods make it inconvenient to disassemble, and relevant parts and fittings are easy to lose. Besides, it is not convenient for the user to use the container as its structure is deficient. Therefore, there is a need for the industry to provide a vacuum container which is easy and convenient to dissemble and assemble.

### BRIEF SUMMARY OF THE INVENTION

It is an object of the present invention to provide a vacuum container which is convenient and easy to disassemble and assemble manually.

To attain this, the present invention provides a vacuum container with a body and a base which are conveniently disassembled and assembled. It comprises a body and a base; the body has a bottom side which is disposed with an upper connecting ring; the base has an upper side which is disposed with a lower connecting ring; the lower connecting ring is disposed with a rotatable fastening member in middle; the fastening member is disposed with an “I”-shaped fastening bar on top; the upper connecting ring is disposed with an “I”-shaped opening for the fastening bar to pass through; the upper connecting ring has an upper side which is disposed with a fastening recess for engaging the fastening bar after the fastening bar (6) rotates 90 degrees.

The upper side of the upper connecting ring is disposed with a guiding cambered surface which corresponds to a bottom surface of the fastening bar and gradually increases in thickness; and the guiding cambered surface extends to the fastening recess.

The fastening member has a lower part disposed with an “I”-shaped positioning bar which is perpendicular to the fastening bar; the lower connecting ring has an upper side disposed with a positioning recess which engages the positioning bar after the positioning bar rotates 90 degrees.

By means of the above, the present invention has the following advantages: The fastening member of the present invention is capable of locking the body and the base together after it is manually rotated for 90 degrees. It is therefore convenient for users to disassemble and assemble. As the fastening member is fixedly disposed on the lower connecting ring, it would not be lost and is therefore convenient to users. The present invention is simple in structure, low in costs, and strong in both practical value and promotional value.

### BRIEF DESCRIPTION OF THE DRAWINGS

A detailed embodiment of the present invention is further illustrated by reference to the accompanying drawings.

FIG. 1 is a perspective view illustrating the fastening member being disposed on the base.

FIG. 2 is a perspective view illustrating the positioning bar being engaged within the positioning recess after the fastening member has rotated 90 degrees on the base.

FIG. 3 is a perspective view illustrating the fastening bar passing through the opening of the body.

FIG. 4 is a perspective view illustrating the fastening bar being engaged within the fastening recess after it has passed through the opening of the body and rotated 90 degrees.

### DETAILED DESCRIPTION OF THE INVENTION

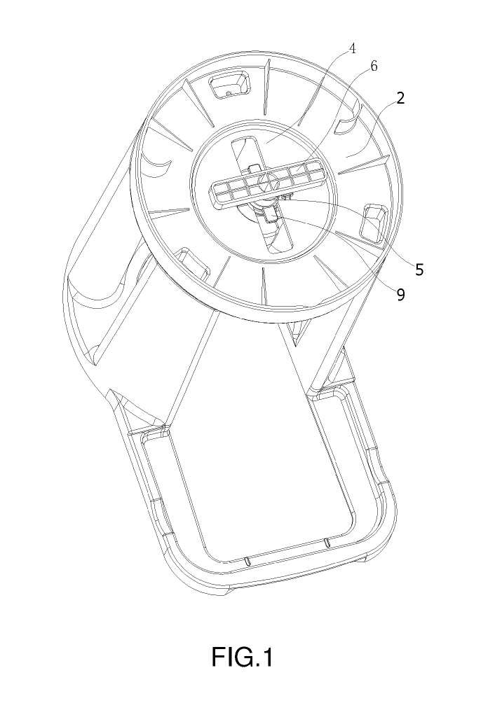

As illustrated in FIGS. 1-4, the vacuum container with a body and a base which are conveniently disassembled and assembled provided by the present invention comprises a body 1 and a base 2. The body 1 has a bottom side which is disposed with an upper connecting ring 3. The base 2 has an upper side which is disposed with a lower connecting ring 4. The lower connecting ring 4 is disposed with a rotatable fastening member 5 in middle. The fastening member is made of plastic material. The fastening member is fixedly disposed on the lower connecting ring and therefore would not be lost. The fastening member 5 is disposed with an “I”-shaped fastening bar 6 on top. The upper connecting ring 3 is disposed with an “I”-shaped opening 7 for the fastening bar 6 to pass through. The upper connecting ring 3 has an upper side which is disposed with a fastening recess 8. The fastening recess 8 engages the fastening bar 6 after it passes through the opening 7 and thereafter rotates 90 degrees. The fastening member 5 has a lower part disposed with an “I”-shaped positioning bar 9 which is perpendicular to the fastening bar 6. The lower connecting ring 4 has an upper side disposed with a positioning recess 10 which engages the positioning bar 9 after the positioning bar 9 rotates 90 degrees. The upper side of the upper connecting ring 3 is disposed with a guiding cambered surface 11 which corresponds to a bottom surface of the fastening bar 6 and gradually increases in thickness. The guiding cambered surface 11 extends to the fastening recess 8. When the fastening bar 6 rotates and engages with the fastening recess 8, the guiding cambered surface 11 which gradually increases in thickness forces the fastening member 5 to tightly lock the body 1 and the base 2 together, thereby attaining secure connection.

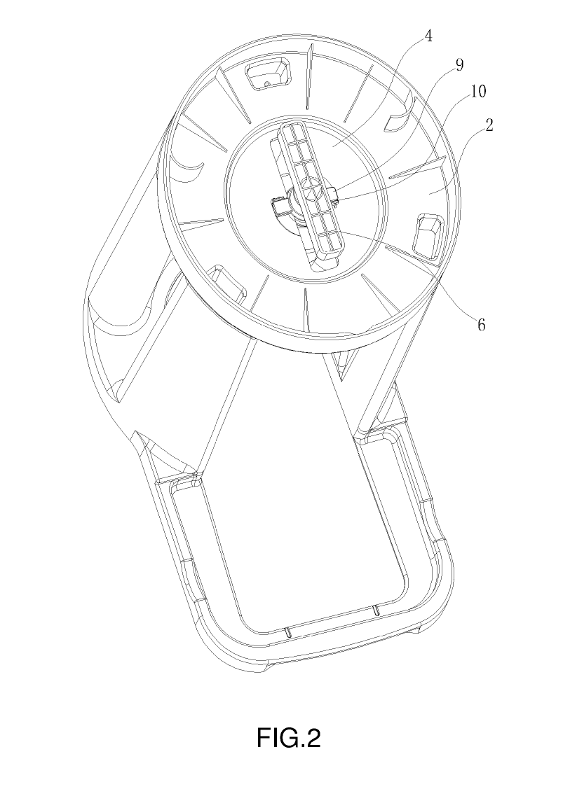

As illustrated in FIGS. 1 and 2, after the fastening member 5 rotates 90 degrees, the positioning bar 9 is engaged within the positioning recess 10. As a result, the fastening member 5 would not rotate in random.

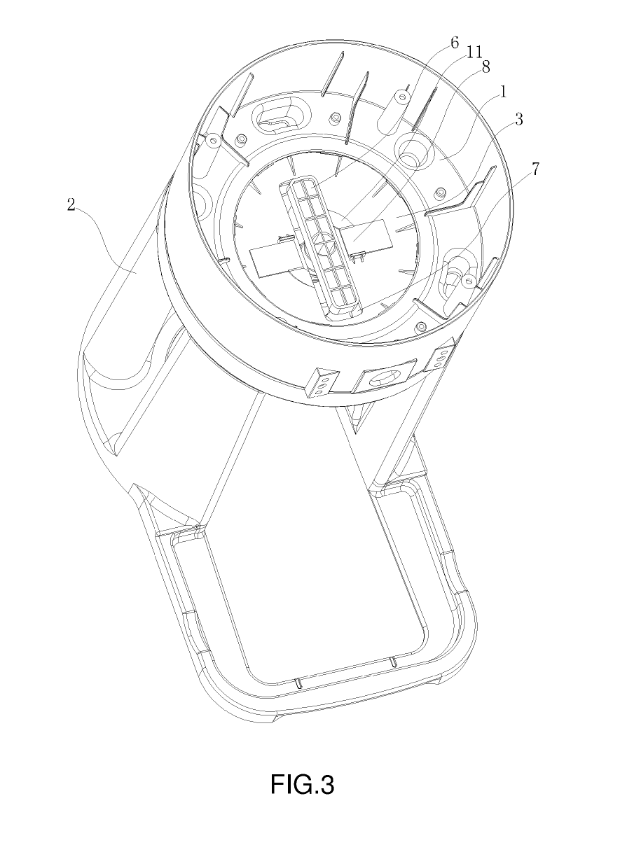

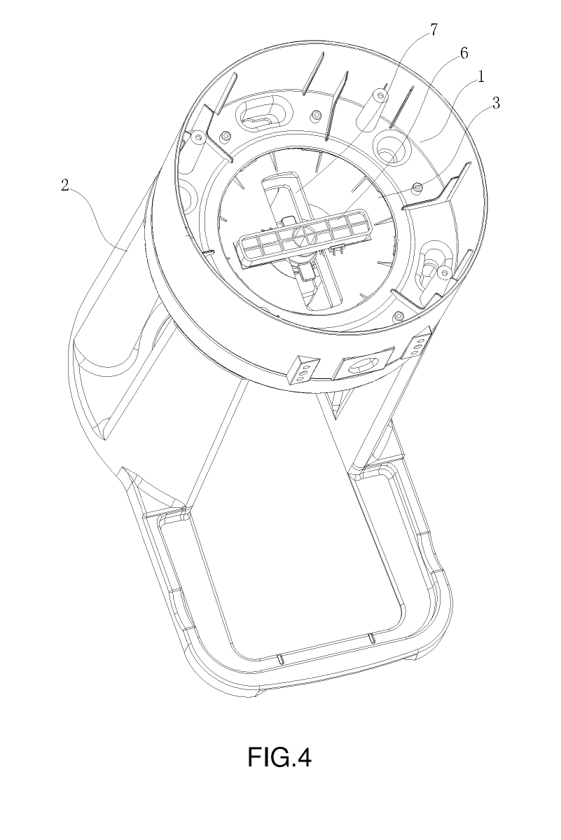

As illustrated in FIGS. 3 and 4, after the fastening bar 6 passes through the opening 7 and thereafter rotates 90 degrees, it is engaged within the fastening recess 8, thereby locking the body 1 and the base 2 together. When it is necessary to disassemble the body 1 and the base 2, the fastening member 5 rotates 90 degrees in an opposition direction, and the fastening bar 6 is then disengaged from the fastening recess 8 and thereafter disengaged from the opening 7. The body 1 and the base 2 could then be disassembled.

The above embodiment is a preferred embodiment of the present invention. However, it should be appreciated that various changes or modifications made by a person skilled in the art which do not deviate from the spirit of the present invention fall within the scope of protection of the present invention.

What is claimed is:

1. A vacuum container with a body and a base which are conveniently disassembled and assembled which comprises a body (1) and a base (2), characterized in that the body (1) has a bottom side which is disposed with an upper connecting ring (3); the base (2) has an upper side which is disposed with a lower connecting ring (4); the lower connecting ring (4) is disposed with a rotatable fastening member (5) in middle;
the fastening member (5) is disposed with an “I”-shaped fastening bar (6) on top; the upper connecting ring (3) is disposed with an “I”-shaped opening (7) for the fastening bar (6) to pass through; the upper connecting ring (3) has an upper side which is disposed with a fastening recess (8) for engaging the fastening bar (6) after the fastening bar (6) rotates 90 degrees.

2. The vacuum container with a body and a base which are conveniently disassembled and assembled as in claim 1, characterized in that the upper side of the upper connecting ring (3) is disposed with a guiding cambered surface (11) which corresponds to a bottom surface of the fastening bar (6) and gradually increases in thickness; and the guiding cambered surface (11) extends to the fastening recess (8).

3. The vacuum container with a body and a base which are conveniently disassembled and assembled as in claim 1 or 2, characterized in that the fastening member (5) has a lower part disposed with an “I”-shaped positioning bar (9) which is perpendicular to the fastening bar (6); the lower connecting ring (4) has an upper side disposed with a positioning recess (10) which engages the positioning bar (9) after the positioning bar (9) rotates 90 degrees.
